(19) United States
(12) Patent Application Publication
(10) Pub. No.: US 2007/0188014 A1
(43) Pub. Date: Aug. 16, 2007

(54) Brake control apparatus for vehicle

(76) Inventors: Takashi Sato, Okazaki-shi (JP); Hiroaki Niino, Toyota-shi (JP)

Correspondence Address: BUCHANAN, INGERSOLL & ROONEY PC, POST OFFICE BOX 1404, ALEXANDRIA, VA, 22313-1404, US

(21) Appl. No.: 11/698,915

(22) Filed: Jan. 29, 2007

(30) Foreign Application Priority Data
Feb. 15, 2006 (JP) 2006-037996

(51) Int. Cl. B60T 13/18

(52) U.S. Cl. 303/11

(57) ABSTRACT

A brake control apparatus for a vehicle includes controlling device having a target wheel cylinder pressure calculating portion, an accumulated motor rotation calculating device, and a motor actuation determining portion, wherein the brake fluid in the first and the second front and rear wheel cylinders are pressurized by driving the first, second, third and fourth linear valves and the first and the second motors when the necessary amount of brake fluid is judged to be larger than the current amount of brake fluid and the brake fluid in the first and the second front wheel cylinders, and the pressurizing of the first and the second rear wheel cylinders are stopped by reducing the number of rotations or stopping the rotation of the first and the second motors when the necessary amount of brake fluid is judged not to be larger than the current amount of brake fluid.

### CROSS REFERENCE TO RELATED APPLICATIONS

This application is based on and claims priority under 35 U.S.C. § 119 to Japanese Patent Application 2006-037996, filed on Feb. 15, 2006, the entire content of which is incorporated herein by reference.

### FIELD OF THE INVENTION

The present invention relates to a brake control apparatus for a vehicle in which a pump is employed to generate pressure (hereinafter referred to as W/C pressure) at a wheel cylinder (hereinafter, W/C).

### BACKGROUND

Heretofore, JP10-203338A (corresponding to US006113197A) proposes a vehicle brake control apparatus of a brake-by-wire type, which has four pumps respectively for four wheels of a vehicle. Two of the four pumps are located in a first conduit system and driven by a common motor, and the other two of the four pumps are located in a second conduit system and are driven by another common motor.

According to such known brake-by-wire type brake control apparatus for a vehicle, each motor for actuating a control valve and the pump, which are provided at each conduit system, is basically driven by electric power supplied by a battery. Because driving motors consume a large amount of electric power, electric power to be consumed by two motors needs to be reduced as much as possible.

The present invention has been made in view of the above description and provides a brake-by-wire type brake control apparatus for a vehicle, in which power consumption by the motors is reduced.

### SUMMARY OF THE INVENTION

According to an aspect of the present invention, controlling means includes a target wheel cylinder pressure calculating portion for calculating a target wheel cylinder pressure corresponding to the operation amount detected by the operation amount sensor and calculating a necessary amount of brake fluid necessary for generating the wheel cylinder pressure corresponding to the target wheel cylinder pressure when the brake operating member is detected to be operated, an accumulated motor rotation calculating means for calculating an accumulated number of rotations of each of the first and the second motors on the basis of a detection signal from the first and the second rotation sensors after the brake operating member is operated, and a motor actuation determining portion determining whether the necessary amount of brake fluid is larger than a current amount which is calculated by multiplying the brake fluid discharged from the first, second, third and fourth pumps per one rotation of the first and the second motors by the accumulated number of rotation, wherein the brake fluid in the first and the second front wheel cylinders and the first and the second rear wheel cylinders are pressurized by driving the first, second, third and fourth linear valves and the first and the second motors when the necessary amount of brake fluid is judged to be larger than the current amount of brake fluid and the brake fluid in the first and the second front wheel cylinders, and the pressurizing of the first and the second rear wheel cylinders are stopped by reducing the number of rotations or stopping the rotation of the first and the second motors when the necessary amount of brake fluid is judged not to be larger than the current amount of brake fluid.

### BRIEF DESCRIPTION OF THE DRAWINGS

The foregoing and additional features and characteristics of the present invention will become more apparent from the following detailed description considered with reference to the accompanying drawings, wherein:

FIG. 1 illustrates a view indicating a configuration of a fluid pressure circuit of a brake control apparatus for a vehicle according to a first embodiment of the present invention;

FIG. 2 illustrates a block view indicating a relationship of input and output of a signal of a brake ECU serving as a control system of the brake control apparatus illustrated in FIG. 1;

FIG. 3 illustrates a characteristic diagram between brake fluid amount and target W/C pressure;

FIG. 4 illustrates a flowchart of a controlling process of a motor actuation executed in a brake ECU in a normal brake operation;

FIG. 5 illustrates a view indicating a configuration of a fluid pressure circuit of a brake control apparatus for a vehicle according to a second embodiment of the present invention;

FIG. 6 illustrates a view indicating a configuration of a fluid pressure circuit of a brake control apparatus for a vehicle according to a third embodiment of the present invention;

FIG. 7 illustrates a view indicating a configuration of a fluid pressure circuit of a brake control apparatus for a vehicle according to another embodiment of the present invention; and

FIG. 8 illustrates a view indicating a configuration of a fluid pressure circuit of a brake control apparatus for a vehicle according to another embodiment of the present invention.

### DETAILED DESCRIPTION

Embodiments of the present invention will be explained below with reference to the drawings. In the embodiments below, identical reference symbols are used in the drawings to represent identical or equivalent elements.

### First Embodiment

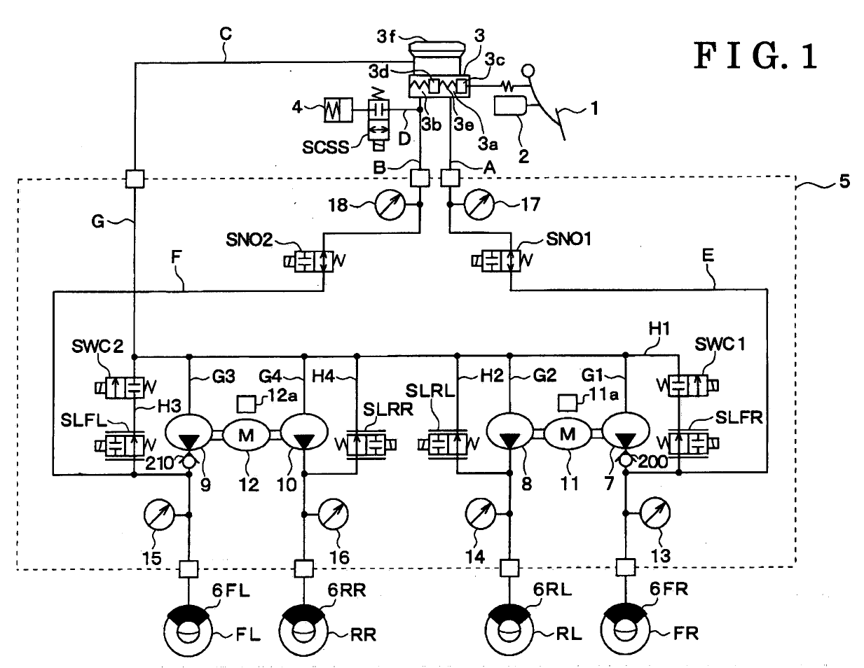

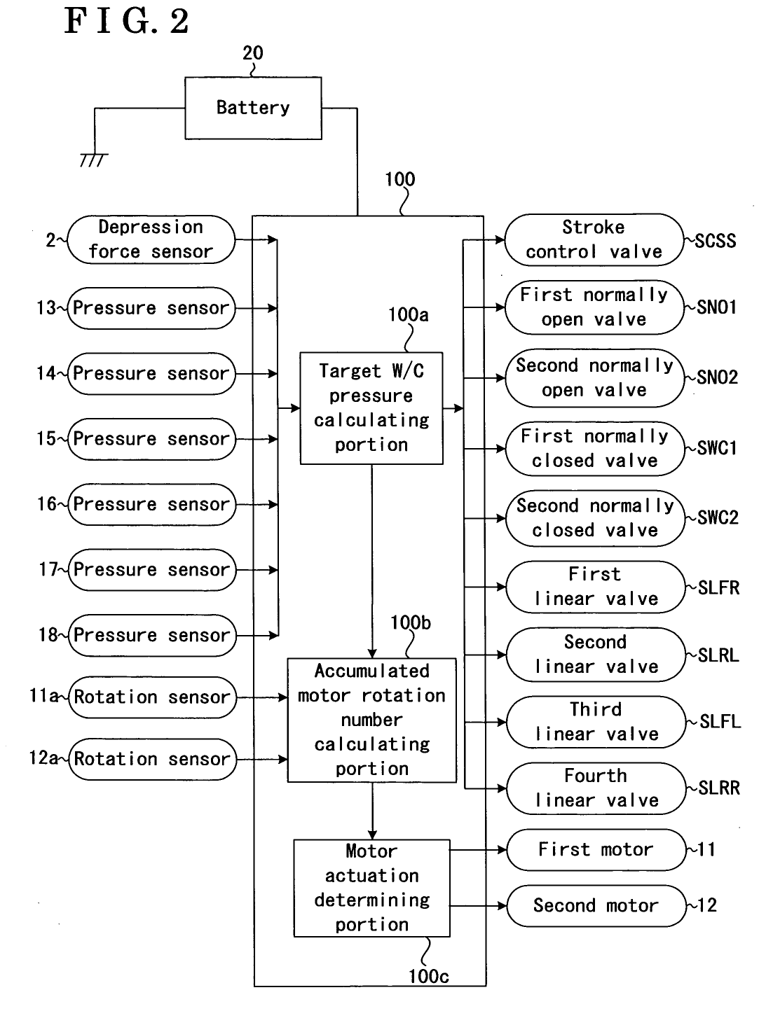

FIG. 1 illustrates a configuration of a fluid pressure circuit of a brake control apparatus for a vehicle according to a first embodiment of the present invention. FIG. 2 illustrates input and output relationships of signals of a brake system ECU 100 (controlling means) serving as a control system of the brake control apparatus for the vehicle illustrated in FIG. 1. Explained hereinafter is a structure of the brake control apparatus for a vehicle with reference to the drawings. Here, the brake control apparatus for the vehicle is applied to a vehicle having a fluid pressure circuit with a cross (X) dual conduit system (diagonal conduit system), one conduit system for front-right and rear-left wheels and the other conduit system for front-left and rear-light wheels.

As illustrated in FIG. 1, the brake control apparatus for the vehicle includes, in addition to the brake system ECU 100 (FIG. 2), a brake pedal 1, a depression force sensor 2 for the brake pedal 1, a brake master cylinder (hereinafter referred to as M/C) 3, a stroke control valve SCSS, a stroke simulator 4, a brake fluid pressure control actuator 5 and four wheel cylinders for each vehicle wheel (hereinafter referred to as W/C) 6FL, 6FR, 6RL and 6RR. The W/C 6FL serves as a first front wheel cylinder, the W/C 6FR serves as a second front wheel cylinder, the W/C 6RL serves as a first rear wheel cylinder, the W/C 6RR serves as a second rear wheel cylinder.

Once the brake pedal 1, which is an example of a brake operating member, is depressed by a driver or user, the depression force applied to the brake pedal 1, serving as a brake operating member, is inputted into the depression force sensor 2, serving as an operation amount sensor. The depression force sensor 2 outputs a detection signal corresponding to the level of depression force applied to the brake pedal 1. This detection signal is inputted into the brake system ECU 100 and the brake system ECU 100 stores the depression force applied to the brake pedal 1. According to the first embodiment, the depression force sensor 2 is employed as an example of an operation amount sensor for detecting an operation amount of the brake operating member. However, a stroke sensor or the like can be employed as long as the operation amount of the brake pedal 1 can be detected. Further, as an alternative method for detecting the operation amount of the brake operating member, a state of operation of the brake pedal 1 can be detected on the basis of a detection signal of a stroke sensor or detection signals of pressure sensors 17 and 18 for detecting the pressure at the M/C (which will be described later in detail).

The brake pedal 1 is connected to a push rod, or the like for transmitting the depression force applied to the brake pedal 1 to the M/C 3. In response to a movement of the push rod, M/C pressure is generated in a primary chamber 3a and a secondary chamber 3b, both of which are defined in the M/C 3.

In the M/C 3, a primary piston 3c and a secondary piston 3d are disposed to define the primary chamber 3a and the secondary chamber 3b. The primary piston 3c and the secondary piston 3d normally receive an elastic force of a spring 3e to keep or return the brake pedal 1 to its initial non-braking position when the brake pedal 1 is not depressed, i.e., when the brake pedal 1 is free from depression force.

The primary chamber 3a of the M/C 3 is connected to a conduit A, while the secondary chamber 3b thereof is connected to a conduit B. The conduits A and B extend to a brake fluid pressure control actuator 5, respectively.

The M/C 3 is provided with a master reservoir (reservoir) 3f. When the brake pedal 1 is in the initial position, the master reservoir 3f communicates with the primary chamber 3a and the secondary chamber 3b via passages (not-illustrated), wherein the master reservoir 3f supplies brake fluid into the M/C 3 or stores surplus brake fluid of the M/C 3.

A conduit C directly extends from the master reservoir 3f to the brake fluid pressure control actuator 5.

The stroke simulator 4 is connected to a conduit D communicating with the conduit B and the stroke simulator 4 reserves therein brake fluid of the secondary chamber 3b, serving as a reservoir for the secondary chamber 3b. The conduit D is provided with the stroke control valve SCSS that is a normally closed type valve and can be controlled in two-positions, namely, an open position and a closed position, so that fluid communication in the conduit D is selectively established or interrupted. Therefore, this stroke control valve SCSS controls the brake fluid flow to the stroke simulator 4. In this embodiment, the conduit D connected to the stroke simulator 4 is communicating with the conduit B, however, the conduit D may communicate with the conduit A.

Described below is a structure of the brake fluid pressure control actuator 5.

A conduit E is connected to the conduit A so that the primary chamber 3a of the M/C 3 communicates with a W/C (first front W/C) 6FR for the front wheel FR (first front wheel). The conduit E is mounted with a first normally open valve SNO1 controlled in two-positions. The first normally open valve SNO1 is controlled in an open position when not electrically energized so that fluid communication in the conduit E is established. On the other hand, the first normally open valve SNO1 is controlled in a closed position when electrically energized so that the fluid communication in the conduit E is interrupted.

A conduit F is connected to the conduit B so that the secondary chamber 3b of the M/C 3 communicates with another W/C (second front W/C) 6FL for the front wheel FL (second front wheel). The conduit F is mounted with a second normally open valve SNO2 controlled in two-positions. The second normally open valve SNO2 is controlled in an open position when not electrically energized so that fluid communication in the conduit F is established. On the other hand, the second normally open valve SNO2 is controlled in a closed position when electrically energized so that the fluid communication in the conduit F is interrupted.

A conduit G is connected to the conduit C extending from the master reservoir 3f. The conduit G branches to four conduits G1 (first conduit), G2 (second conduit), G3 (third conduit) and G4 (fourth conduit). Each conduit G1, G2, G3 or G4 is connected to each W/C (first front wheel W/C) 6FR, W/C (first rear wheel W/C) 6RL, W/C (second front wheel W/C) 6FL or W/C (second rear wheel W/C) 6RR. The W/C 6RL is mounted on a rear wheel RL (first rear wheel) while the W/C 6RR is mounted on a rear wheel RR (second rear wheel).

The conduits G1, G2, G3 and G4 are provided with four pumps (first, second, third and fourth pumps) 7, 8, 9 and 10, respectively. Each pump 7, 8, 9 and 10 is a trochoid pump which is effective for example for quietness. The pumps 7 and 8 are driven by a first motor 11, while the pumps 9 and 10 are driven by a second motor 12. Although any type of motor can be applicable as the first and second motors 11 and 12, it is preferable to employ a brushless motor which normally has a quick starting time. Further, the first motor 11 includes a rotation sensor 11a, serving as a first rotation sensor, and the second motor 12 includes a rotation sensor 12a, serving as a second rotation sensor. Each of the first and second rotation sensors 11a and 12a outputs a detection signal corresponding to a number of rotations, for example a rotation angle, of each of the first and second motors 11 and 12, and the detection signal is inputted by the brake ECU 100.

The pumps 7, 8, 9 and 10 are provided with conduits H1, H2, H3 and H4 respectively, serving as first, second, third and fourth pressure modulating circuit. Each conduit H1, H2, H3 and H4 forms a modulating circuit for each pump and is arranged in parallel with each corresponding pump.

A first normally closed valve SWC1 and a first linear valve SLFR are in series provided in the conduit H1 connected in parallel to the pump 7. The first normally closed valve SWC1 is positioned upstream of the pump 7 (an intake port side of the pump 7) and the linear valve SLFR is positioned downstream of the pump 7 (a discharge port side of the pump 7). Therefore, the first normally closed valve SWC1 controls the brake fluid return flow toward the master reservoir 3f via the conduit H1.

The conduit H2, which is connected in parallel to the pump 8, is mounted with a second linear valve SLRL.

A second normally closed valve SWC2 and a third linear valve SLFL are in series provided in the conduit H3 connected in parallel to the pump 9. The second normally closed valve SWC2 is positioned upstream of the pump 9 (an intake port side of the pump 9) and the third linear valve SLFL is positioned downstream of the pump 9 (a discharge port side of the pump 9). Therefore, the second normally closed valve SWC2 controls the brake fluid return flow toward the master reservoir 3f via the conduit H3.

The conduit H4, which is connected in parallel to the pump 10, is mounted with a fourth linear valve SLRR.

The conduits G1, G2, G3 and G4 are provided with W/C pressure sensors (first, second, third and fourth pressure sensors) 13, 14, 15 and 16 between the pumps 7, 8, 9 and 10 and the W/Cs 6FR, 6RL, 6FL and 6RR, respectively. Each W/C pressure sensor 13-16 detects W/C pressure of each wheel cylinder. Further, the M/C pressure sensors 17 and 18 are respectively located in the brake conduits E and F on the upstream sides (the M/C 3 sides) of the first and second normally open valves SNO1 and SNO2. The M/C pressure sensors 17 and 18 detect M/C pressure generated in the primary chamber 3a and the secondary chamber 3b of the M/C 3, respectively.

The W/C 6FR of the front wheel FR is supplied with a pressurized fluid discharged from the discharge port of the pump 7 to generate the brake pressure at the W/C 6FR. A check valve 200 is mounted at the discharge port of the pump 7. The W/C 6FL of the front wheel FL is supplied with a pressurized fluid discharged from the discharge port of the pump 9 to generate the brake pressure at the W/C 6FR. A check valve 210 is mounted at the discharge port of the pump 9. The check valves 200 and 210 prevent the flow of brake fluid from the W/Cs 6FR and 6FL to the pumps 7 and 9, respectively. As described above, these components form the brake fluid pressure control actuator 5.

In the brake control apparatus for the vehicle as described above, a first conduit system is structured with a fluid pressure circuit (first auxiliary conduit), which connects the primary chamber 3a of the M/C 3 with the W/C 6FR via the conduits A and E, a fluid pressure circuit (main conduit), which connects the master reservoir 3f with the W/Cs 6FR and 6RL via the conduits C, G, G1 and G2, and fluid pressure circuits (first and second pressure modulating circuits) of the conduits H1 and H2 connected in parallel to the pumps 7 and 8.

A second conduit system is structured with a fluid pressure circuit (second auxiliary conduit), which connects the secondary chamber 3b of the M/C 3 with the W/C 6FL via the conduits B and F, a fluid pressure circuit (the main conduit), which connects the master reservoir 3f with the W/Cs 6FL and 6RR via the conduit C, the conduit G, and the conduits G3 and G4, and fluid pressure circuits (third and fourth pressure modulating circuits) of the conduits H3 and H4 connected in parallel to the pumps 9 and 10 respectively.

As illustrated in FIG. 2, the brake system ECU 100 is inputted with detection signals of the depression force sensor 2, the pressure sensors 13-18.

The brake system ECU 100 is configured with a known microcomputer provided with a CPU, a ROM, a RAM, an I/O and so on and executes various processes in accordance with programs stored in the ROM or the like. The brake system ECU 100 is provided with semiconductor switching elements (not illustrated). These switching elements are on/off controlled to on/off control electric power supply lines to various components, such as the control valves SCSS, SNO1, SNO2, SWC1, SWC2, SLFR, SLRL, SLFL and SLRR, the first and second motor 11 and 12, so that the amount of electric current supplied per unit time (consumption power amount) to these components is controlled.

More specifically, the brake ECU 100 incorporates therein a target W/C pressure calculating portion 100a; a accumulated motor rotation calculating portion 100b, serving as a accumulated motor rotation calculating means; a motor actuation determining portion 100c, and so on.

The target W/C pressure calculating portion 100a calculates a target W/C pressure required to generate a target braking force. More specifically, the target W/C pressure calculating portion 100a first calculates a physical value of depression force which corresponds to a brake operating amount, based upon a detection signal of the depression force sensor 2. The target W/C pressure calculating portion 100a then calculates a target braking force, which corresponds to the physical value of depression force and calculates the target W/C pressure, which is required to generate the target braking force. The target W/C pressure calculating portion 100a also calculates a requisite amount of the brake fluid required for the calculated target braking force.

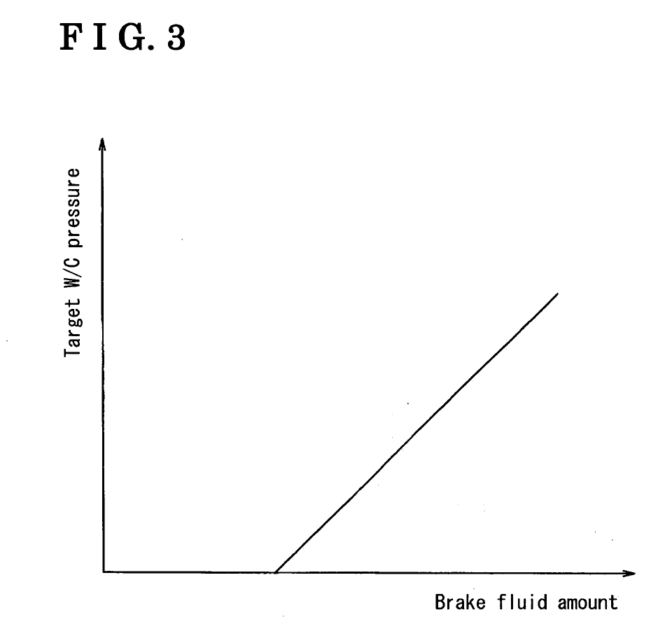

After the target W/C pressure corresponding to a brake operating amount is obtained, as illustrated in FIG. 3, on the basis of a characteristic chart with an amount of brake fluid as an x-axis and a target W/C pressure as a y-axis, necessary amount of brake fluid is obtained. Specifically, as is explained in FIG. 3, a target W/C pressure is not generated or does not rise regardless of an increasing amount of brake fluid supplied while a brake caliper is supplied with brake fluid at an ineffectively consumed fluid volume, i.e., until a brake caliper is supplied with brake fluid over the maximum of an ineffectively consumed fluid volume. Once the brake caliper is supplied with brake fluid over the maximum of the ineffectively consumed fluid volume, a target W/C pressure is increased in proportion to an increase in an amount of brake fluid supplied. Therefore, once the target W/C pressure calculating portion 100a identifies a level of a target W/C pressure, the target W/C pressure calculating portion 100a can compute, based upon this characteristic chart or a formula representing the relationship between an amount of brake fluid (x-axis) and a target W/C pressure (y-axis), a necessary amount of brake fluid corresponding to the target W/C pressure.

The first motor 11 includes the rotation sensor 11a, the second motor 12 includes the rotation sensor 12a, and each of which outputs a detection signal corresponding to the number of rotations, the accumulated motor rotation calculating portion 100b calculates an accumulated number of rotations of each of the first and second motors 11 and 12 on the basis of the detection signal outputted by each rotation sensor 11a and 12a.

The motor actuation determining portion 100c determines, on the basis of the calculated results by the target W/C pressure calculating portion 100a and the accumulated motor rotation calculating portion 100b, whether or not the motors need to be actuated. Description of the determining process will be explained later.

Further, on the basis of the calculated and determined results by the target W/C pressure calculating portion 100a, the accumulated motor rotation calculating portion 100b and the motor actuation determining portion 100c, the brake ECU 100 outputs control signals for actuating each control valve SCSS, SNO1, SNO2, SWC1, SWC2, SLFR, SLRL, SLFL and SLRR, and each first and second motor 11 and 12, so that a W/C pressure is generated at each W/C6 FR-6RR. The brake ECU 100 computes W/C pressure and M/C pressure on the basis of a detection signal of each pressure sensor 13 to 18 and feedbacks an actually generated braking force (actual braking force) to approximate a target barking force.

At this point, as illustrated in FIG. 2, the control signals for actuating each control valve SCSS, SNO1, SNO2, SWC1, SWC2, SLFR, SLRL, SLFL and SLRR and the first and second motors 11 and 12 are outputted by the brake ECU 100 on the basis of electric power supplied by a battery 20 mounted on the vehicle.

The operation of the brake control apparatus during normal braking operation operation and in an abnormal situation will be explained below separately.

Table 1 shows the operating states of portions of the brake control apparatus during the normal braking operation and in the abnormal situation. The brake ECU 100 determines, by executing a conventional initial check or the like, whether the abnormal situation has occurred. Once the abnormal situation arises, abnormal-state braking operation is executed until the abnormal situation is released.

TABLE 1

| | Normal Brake operation | Abnormal Situation |
|---|---|---|
| SNO1 | ON (Disconnecting) | OFF (Connecting) |
| SNO2 | ON (Disconnecting) | OFF (Connecting) |
| SWC1 | ON (Connecting) | OFF (Disconnecting) |
| SWC2 | ON (Connecting) | OFF (Disconnecting) |
| SLFR | DUTY | OFF (Connecting) |
| SLRL | DUTY | OFF (Connecting) |
| SLFL | DUTY | OFF (Connecting) |
| SLRR | DUTY | OFF (Connecting) |
| SCSS | ON (Connecting) | OFF (Disconnecting) |
| 1st, 2nd Motors | ON/OFF variable control | OFF |

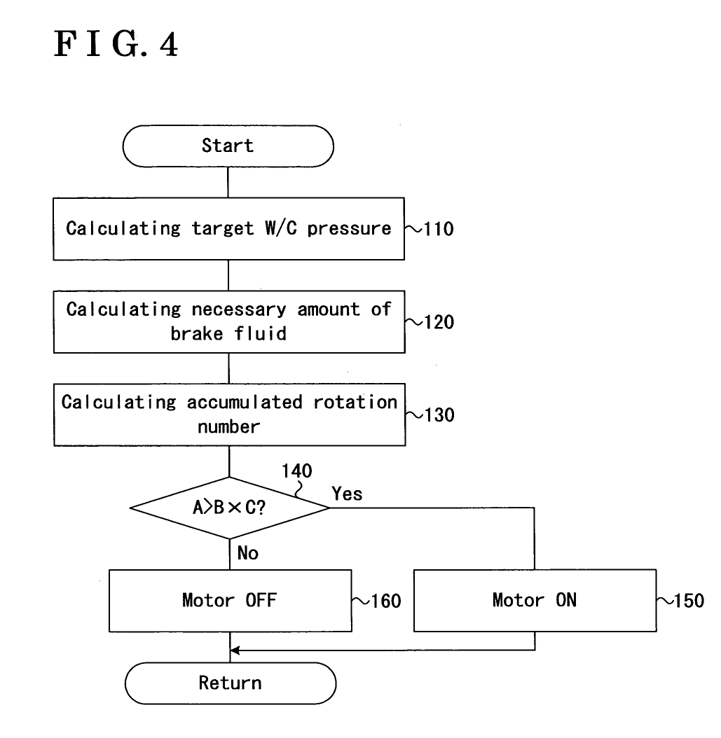

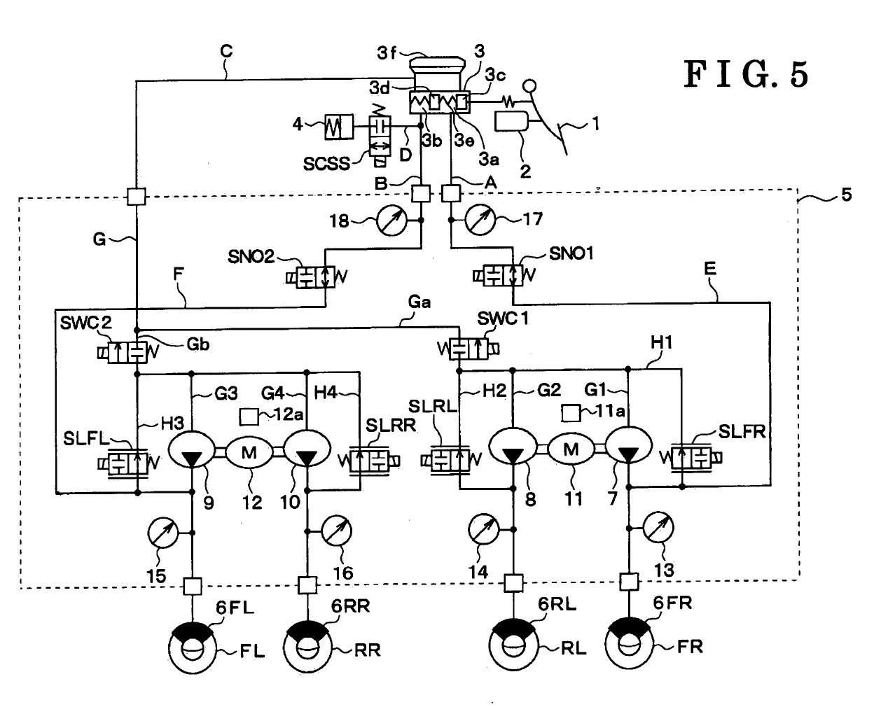

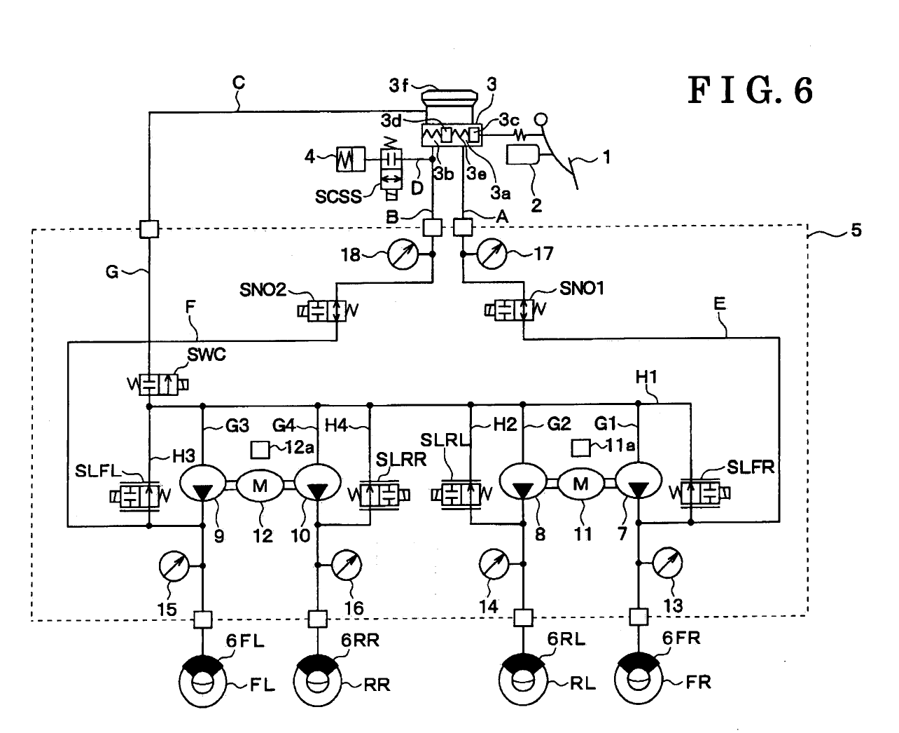

FIG. 4 is a flowchart for explaining a motor driving control implemented by the brake ECU 100 during the normal braking operation. The program in FIGS. 5 and 6 for a motor driving control is performed every operation cycle of the brake ECU 100 in a situation where the depression force sensor 2 detects depression of the brake pedal 1.

Described below is an operation during a normal braking operation or in an abnormal situation with reference to the flowcharts in FIGS. 4 and 5.

(1) Operation During the Normal Braking Operation

During normal braking operation, when the brake pedal 1 is depressed and the detection signal of the depression force sensor 2 is inputted to the brake ECU 100, the brake ECU 100 computes a target W/C pressure, a necessary amount of brake fluid A corresponding to the target W/C pressure, and an accumulated number of rotations B of each first and second motor 11 and 12 (S110-130 in FIG. 4). The target W/C pressure calculating portion 100a and the accumulated motor rotation calculating portion 100b of the brake ECU 100 implements this computing.

In S140, discharge amount of brake fluid C of each pump 7 8 and 9 for each single rotation of the motor is obtained, and a current amount of brake fluid (B×C) is obtained by following formula: Accumulated number of rotations B×Discharge amount of brake fluid C.

Then, it is determined whether or not the current amount of brake fluid (B×C) fulfills the following relational formula: Necessary amount of brake fluid A>Current amount of brake fluid B×C. The motor actuation determining portion 100c of the brake ECU 100 executes this determination.

On the basis of the relational formula, it is determined whether or not each first and second motor 11 and 12 is actuated. Specifically, if the formula “accumulated number of rotations B×discharge amount of brake fluid C<necessary amount of brake fluid A” is fulfilled, it is determined that the brake fluid amount discharged by each pump 7-11 until the current calculation cycle is less than the necessary amount of brake fluid A. In this case, the process goes to S150. In S150, “motor ON” is set and the process is completed. On the other hand, if the formula “accumulated number of rotations B×discharge amount of brake fluid C>necessary amount of brake fluid A” is fulfilled, it is determined that the brake fluid amount discharged by the pumps 7-11 until the current calculation cycle is larger than the necessary amount of brake fluid A. In this case, the process goes to S160. In S160, “motor OFF” is set and the process is completed. “motor OFF” will be explained later.

Thus, immediately after the brake pedal 1 is depressed, because the brake fluid amount discharged by each pump 7-11 is less than the necessary amount of brake fluid A, “motor ON” is set, and a braking force is generated at each wheel FR-RR.

More specifically, according to the first embodiment of the present invention, each control valve SCSS, SNO1, SNO2, SWC1, SWC2, SLFR, SLRL, SLFL and SLRR and each motor 11 and 12 are driven respectively so as to achieve the state illustrated in Table 1.

Then, the first and second normally open valves SNO1 and SNO2 are turned on and the first and second normally closed valves SWC1 and SWC2 are also turned on. As a result, the first and second normally open valves SNO1 and SNO2 each turn to a disconnecting state (closed state), while the first and second normally closed valves SWC1 and SWC2 each turn to a connecting state (open state).

Turning on or off of each linear valve SLFR, SLRL, SLFL and SLRR is duty controlled, or PWM (Pulse Width Modulation) controlled under which the amount of electric power supplied per unit of time to each linear valve is adjusted, so that pressure differential between the upstream and downstream sides of each linear valve is controlled linearly. The stroke control valve SCSS is turned on and the stroke simulator 4 turns to a connecting state (open state), i.e., communicates with the secondary chamber 3b via the conduits B and D. Therefore, even if the pistons 3c and 3d move in response to the depression on the brake pedal 1, brake fluid in the secondary chamber 3b flows into the stroke simulator 4. As a result, a user or driver can feel a reaction force corresponding to the depression force applied to the brake pedal 1. Further, the user or driver can depress the brake pedal 1 without feeling like depressing a solid plate, which feeling may be created due to the M/C pressure at an extremely high pressure level.

Even further, once each motor 11 and 12 is supplied with electric current, each pump 7, 8, 9 and 10 draws in or discharges brake fluid. When each pump 7, 8, 9 and 10 operates in such a way, brake fluid is supplied to each W/C 6FR, 6RL, 6FL and 6RR.

Here, each first and second normally open valve SNO1 and SNO2 is in a disconnecting state, and brake fluid pressure at the downstream of each pump 7, 8, 9 and 10, i.e., W/C pressure in each W/C 6FR, 6RL, 6FL and 6RR is increased. Further, each first and second normally closed valve SWC1 and SWC2 is in a connecting state, and electric current per unit of time supplied to each linear valve SLFR, SLRL, SLFL and SLRR is duty controlled. Therefore, W/C pressure of each W/C 6FR, 6RL, 6FL and 6RR is modulated according to the duty ratio of the duty control.

The brake system ECU 100 monitors the W/C pressure generated at each W/C 6FR, 6RL, 6FL and 6RR of each wheel, on the basis of a detection signal of each pressure sensor 13, 14, 15 and 16. The brake system ECU 100 accordingly adjusts each W/C pressure to a desired value by adjusting an amount of electric current supplied to each motor 11 and 12 so as to control the rotation speed (rotation angle) thereof and by controlling the duty ratio for turning on or off of the electric current supply to each linear valve SLFR, SLRL, SLFL and SLRR.

As described above, As described above, braking force is generated so as to be a target braking force corresponding to brake a depressing force applied to the brake pedal 1.

When it is determined that the brake fluid amount discharged by the pumps 7-11 exceeds the necessary amount of brake fluid A, “motor OFF” is set. Thus, a W/C pressure at each W/C 6FR-6RR is maintained at a target W/C pressure, as a result, a braking force reaching a target braking force is generated.

In this embodiment, “motor OFF” does not only mean that actuations of the first and second motors 11 and 12 are completely stopped.

For example, each linear valve SLFR, SLRL, SLFL and SLRR is controlled so that W/C pressure of each W/C 6FR, 6RL, 6FL and 6RR is modulated so as to be the target W/C pressure. In order to modulate the W/C pressure appropriately, the first to fourth linear valves SLFR, SLRL, SLFL and SLRR may be controlled in a manner where brake fluid leaks therefrom.

In this situation, actuations of the first and second motors 11 and 12 are not stopped, and the first and second motors 11 and 12 need to be actuated so that each pump 7-10 can supply a certain amount of brake fluid, which corresponds to the amount of the brake fluid leaked from the first to fourth linear valves SLFR, SLRL, SLFL and SLRR.

Thus, even though there is an indication showing “motor OFF” in this embodiment, when the first to fourth linear valves SLFR, SLRL, SLFL and SLRR need to be controlled so that brake fluid can leak therefrom, the motors 11 and 12 are controlled so that their rotating number is reduced so that the each pump 7-10 can supply brake fluid corresponding to the brake fluid leaked from the first to fourth linear valves SLFR, SLRL, SLFL and SLRR. Further, when the brake fluid is not being leaked, if each first to fourth linear valve SLFR, SLRL, SLFL and SLRR is a ball valve, and the pressure can be controlled by each valve, the indication showing “motor OFF” means that the first and second motors 11 and 12 are stopped.

Then, because a necessary amount of brake fluid A varies depending on a level of depression on the brake pedal 1, “motor OFF” or “motor ON” is set depending on the determination in S140 in FIG. 4, and pressure differential of each linear valve SLFR, SLRL, SLFL and SLRR is then controlled so that W/C pressure of each W/C 6FR, 6RL, 6FL and 6RR is modulated.

(2) Abnormal-State Braking Operation

When an abnormal situation occurs in the vehicle brake control apparatus, there is a possibility that control signals cannot be outputted from the brake system ECU 100, or that some of the control valves SCSS, SNO1, SNO2, SWC1, SWC2, SLFR, SLRL, SLFL, SLRR or the first and second motors 11, 12 do not operate normally. In this case, electric power to the various control valves SCSS, SNO1, SNO2, SWC1, SWC2, SLFR, SLRL, SLFL, SLRR and the first and second motors 11, 12 are all turned off, as illustrated in Table 1.

In other words, since electric power supply to the first and second normally open valves SNO1 and SNO2 is shut down, both valves SNO1 and SNO2 turn to connecting states (open states). Because electric power supply to the first and second normally closed valves SWC1 and SWC2 is shut down, both valves SWC1 and SWC2 turn to disconnecting states (closed states).

Since the electric power supply to all of the first to fourth linear valves SLFR, SLRL, SLFL, and SLRR is shut down, the first to fourth linear valves SLFR, SLRL, SLFL, and SLRR are in connecting states (open states). Since electric power supply to the stroke control valve SCSS is also supply, the stroke simulator 4 and the secondary chamber 3b are cut off from each other.

Further, electric power supply to the first and second motors 11 and 12 are shut down, and pumps 7, 8, 9 and 10 stop suction and discharge of the brake fluid.

In such circumstances, the primary chamber 3a of the M/C 3 communicates with the W/C 6FR of the front-right wheel FR via the conduits A, E and G1. The secondary chamber 3b of the M/C 3 communicates with the W/C 6FL of the front-left wheel FL via the conduits B, F and G3.

Therefore, when the brake pedal 1 is depressed and the push rod or the like is pushed according to the depression force applied to the brake pedal 1, M/C pressure is generated in the primary chamber 3a and the secondary chamber 3b. The M/C pressure is transmitted to the W/Cs 6FR and 6FL of the front wheels FL and FR. Braking force is generated thereby at both front wheels FR and FL.

According to the first embodiment of the present invention, as described above, the check valves 200 and 210 are installed at the pumps 7 and 9, respectively. Therefore, during operation in such abnormal situation, although W/C pressure in the W/Cs 6FR and 6FL for the front wheels is generated in the conduits G1 and G3, the check valves 200 and 210 enable to prevent the W/C pressure from being applied to the pumps 7 and 9 and further enable to prevent brake fluid from leaking at the pumps 7 and 9. Therefore, it is possible to prevent W/C pressure from decreasing.

As mentioned above, according to the brake control apparatus for a vehicle in this embodiment, it is determined whether the first and second motors 11 and 12 need to be actuated, and if not, the first and second motors 11 and 12 are stopped, or the first and second motors 11 and 12 are actuated by reducing their number of rotations so that the W/C pressure can be maintained to be the target W/C pressure. Thus, an amount of electric power to be consumed by the first and second motors 11 and 12 can be reduced as far as possible, as a result, a total amount of electric power to be consumed by the brake control apparatus for a vehicle can be reduced as much as possible.

Described below is a second embodiment of the present invention. The second embodiment is substantially the same as the first embodiment, apart from that a structure of a brake control apparatus for a vehicle is partially changed from the one of the first embodiment so that only the different portions will be described hereinbelow.

FIG. 5 illustrates a configuration of a fluid pressure circuit of a brake control apparatus for a vehicle according to the second embodiment. As illustrated herein, the conduit G branches to a conduit Ga (first one) and a conduit Gb (second one). The first normally closed valve SWC1 is mounted at the conduit Ga, i.e., at a downstream side of a branching point of the conduit G and at an upstream side of the conduits H1 and H2. The second normally closed valve SWC2 is mounted at the conduit Gb, i.e., at a downstream side of the branching point of the conduit G and at an upstream side of the conduits H3 and H4.

In this configuration, it is determined whether or not the first and second motors 11 and 12 need to be actuated, and if not, the first and second motors 11 and 12 are stopped, or the first and second motors 11 and 12 are actuated by reducing their number of rotations so that the W/C pressure can be maintained to be (reach) the target W/C pressure, so that same effects as in the first embodiment can be obtained.

Further, for example should the first normally closed valve SWC1 turn to a disconnecting state in an abnormal situation, only the upstream side of the conduits H1 and H2 turns to be in a disconnecting state. In such circumstances, when M/C pressure is generated at the primary chamber 3a of the M/C 3 in response to depressing the brake pedal 1, fluid at the M/C pressure level is transmitted not only to the W/C 6FR for the front-right wheel FR but also to the W/C6RL for the rear-left wheel RL. Likewise, for example should the second normally closed valve SWC2 turn to a disconnecting state in an abnormal situation, only the upstream side of the conduits H3 and H4 turns to be in a disconnecting state. In such circumstances, when M/C pressure is generated at the secondary chamber 3b of the M/C 3 in response to depressing against the brake pedal 1, fluid at the M/C pressure level is transmitted not only to the W/C6FL for the front-left wheel FL but also to the W/C6RR for the rear-right wheel RR.

As described above, according to the brake control apparatus for a vehicle according to the second embodiment, it is possible to generate W/C pressure at the W/Cs 6FR, 6RL, 6FL and 6RR for all the four wheels FR, RL, FL and RR even in an abnormal situation, which enables to generate braking force in a further balanced manner.

Further, according to the second embodiment, the check valves 200 and 210, which are included in the apparatus of the first embodiment, are not provided. However, even if brake fluid leakage occurs at each pump 7 and 9, the brake fluid flow due to such leakage is blocked by each first and second normally closed valve SWC1 and SWC2. Therefore, reduction in W/C pressure does not occur in the corresponding W/C.

### Third Embodiment

Described below is a third embodiment of the present invention. The third embodiment is substantially the same as the second embodiment, apart from that a structure of a brake control apparatus for a vehicle is partially changed from that of the second embodiment so that only the different portions will be described hereinbelow.

FIG. 6 illustrates a configuration of a fluid pressure circuit of a brake control apparatus for a vehicle according to the third embodiment. As illustrated herein, the brake control apparatus of the third embodiment is provided with a single normally closed valve SWC, which is different from the apparatuses of the first and second embodiments which each are provided with the first and second normally closed valves SWC1 and SWC2. The single normally closed valve SWC is shared by the two conduit systems.

In this configuration, it is determined whether or not the first and second motors 11 and 12 need to be actuated, and if not, the first and second motors 11 and 12 are stopped, or the first and second motors 11 and 12 are actuated by reducing their number of rotations so that the W/C pressure can be maintained to be (reach) the target W/C pressure, so that same effects as in the first embodiment can be obtained.

Further, also according to the above structure, for the case of a normal brake operation, W/C pressures in the W/C 6FR, 6RL, 6FL and 6RR for all the four wheels FR, RL, FL and RR can be modulated as needed. Further, for the case of an abnormal situation, the W/C 6FR, 6RL, 6FL and 6RR for all the four wheels FR, RL, FL and RR can be supplied with fluid at a level of M/C pressure generated in the M/C3 in response to depressing on the brake pedal 1.

Further, as described above, for the case of an abnormal situation, all the four wheels FR, RL, FL and RR of the two conduit systems are applied with M/C pressure. Therefore, it is possible to achieve a space-saving conduit system.

The switchable operating state of the normally closed valve SWC is the same as the one of the first and second normally closed valves SWC1 and SWC2 illustrated in Table 1.

### Other Embodiments

The brake control apparatus for a vehicle illustrated in FIG. 1 is disclosed as an example of a brake structure to which the present invention is applicable. The brake structure is not limited to the one in FIG. 1 and can be modified in various manners.

According to the first embodiment, the brake control apparatus has a cross (X) dual conduit system, one conduit system for the front-right wheel and the rear-left wheel and the other conduit system for the front-left wheel and the rear-right wheel. However, another conduit system, such as a front-rear conduit system, can be applicable.

According to the above-described embodiments, only the conduit C is connected to the master reservoir 3f, and brake fluid is supplied through this conduit C to the first and second conduit systems. However, another conduit can be connected to the master reservoir 3f in addition to the conduit C. In this case, the conduit C can supply brake fluid to the first conduit system, and the additional conduit can supply brake fluid to the second conduit system.

Further, according to the above-described embodiments, for the case of an abnormal situation, in which the pumps 7, 8, 9 and 10 do not function to pressurize brake fluid, the M/C 3 are connected to the first and second conduit systems. Meanwhile, for the case of a normal brake operation, brake fluid is supplied from the master reservoir 3f. However, this brake fluid supply is one of the examples. That is, the M/C3 does not necessarily have to be connected to the first and second conduit systems. Further, the apparatus does not have to be provided with the M/C3. Still further, brake fluid does not have to be supplied by the master reservoir 3f and can be supplied from another reservoir which can store brake fluid.

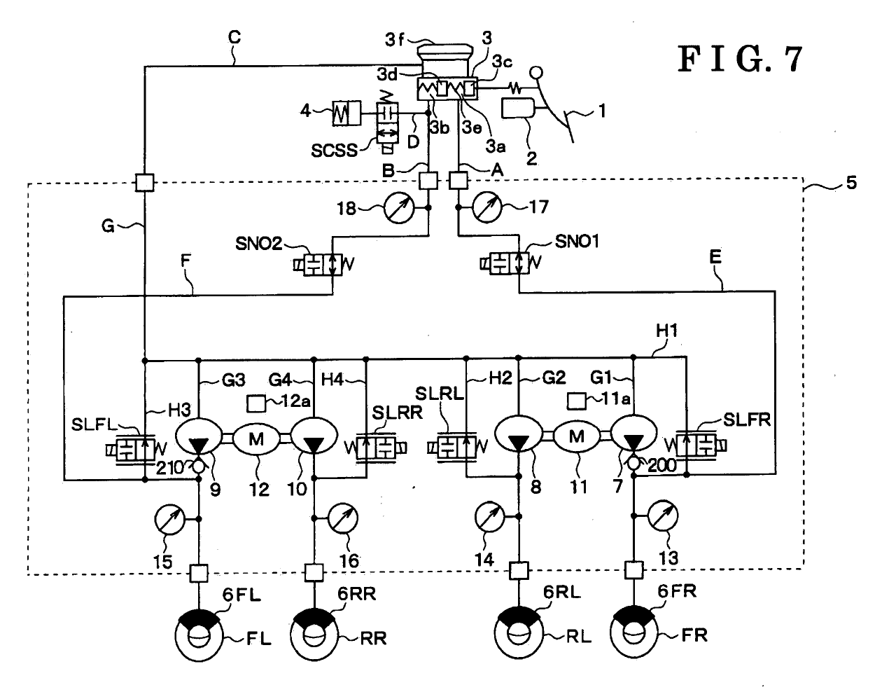

Still further, according to the above-described embodiments, in consideration of a fail safe mode, M/C pressure, which is generated on the basis of depression against the brake pedal 1, can be applied to the W/Cs 6FR, 6RL, 6FL and 6RR even when the linear valves SLFR, SLRL, SLFL and SLRR do not operate properly. However, when an error occurs at a portion different from the linear valves SLFR, SLRL, SLFL and SLRR, these linear valves can be operated. In such circumstances, once the linear valves are electrically excited and the conduits H1, H2, H3 and H4 each turn to be in a disconnecting state (or, in a state where pressure differential between an upstream side and a downstream side of each valve turns to be a value at the maximum), M/C pressure can be applied to the 6FR, 6RL, 6FL and 6RR. Therefore, there is no need to always provide the first and second normally closed valves SWC1, SWC2 and the normally closed valve SWC. That is, as illustrated in FIG. 7, the fluid pressure circuit can have the structure without the first and second normally closed valves SWC1, SWC2 and the normally closed valve SWC.

However, in order to enable to achieve a fail-safe mode all mechanically, the first and second normally closed valves SWC1, SWC2 and the normally closed valve SWC are important.

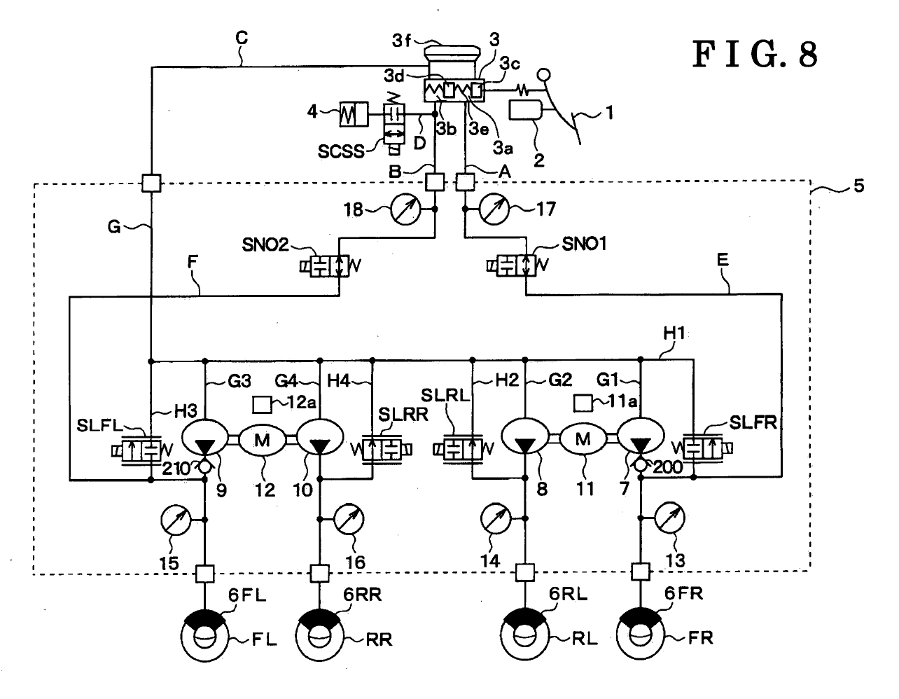

Therefore, as illustrated in FIG. 8, when normally closed linear valves are employed as the first linear valve SLFR and the third linear valve SLFL respectively, it is possible to achieve a fail-safe mode mechanically, which is a more preferable structure. It is possible that normally closed linear valves are employed also for the second and fourth linear valves SLRL and SLRR respectively.

In the above embodiments, the brake pedal 1 is used as an example of the brake operating member, however, the brake operation member may not be limited to the embodiments. For example, the brake operating member may be a brake lever or the like.

On the basis of a comparison result of determining whether the necessary amount of brake fluid is larger than a current amount, it is determined whether the first and second motors and need to be actuated, and if not, the first and second motors are stopped, or the first and second motors are actuated by reducing their number of rotations so that the W/C pressure can be maintained to be the target W/C pressure. Thus, an amount of electric power to be consumed by the first and second motors can be reduced as far as possible, as a result, a total amount of electric power to be consumed by the brake control apparatus for a vehicle can be reduced as much as possible.

The amount of electric power to be consumed by the first and second motors can be reduced while the brake fluid discharged from the first, second, third and fourth linear valves becomes a brake fluid level capable of pressure modulation.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. A brake control apparatus for a vehicle, comprising:
a brake operating member operated by an operator of the vehicle;
an operation amount sensor for detecting an operation amount of the brake operating member;
first and second front wheel cylinders mounted at first and second front wheels of the vehicle respectively;
first and second rear wheel cylinders mounted at first and second rear wheels of the vehicle respectively;
a reservoir for storing brake fluid;
a main conduit connecting the first and second front wheel cylinders and the first and second rear wheel cylinders with the reservoir, the main conduit branching into four conduits respectively connected with the first and second front wheel cylinders and the first and second rear wheel cylinders;
a first pump located in the first one of the four conduits for supplying pressurized brake fluid in the first front wheel cylinder by suction and discharging the brake fluid stored in the reservoir;
a second pump located in the second one of the four conduits for supplying pressurized brake fluid in the first rear wheel cylinder by suction and discharging the brake fluid stored in the reservoir;
a third pump located in the third one of the four conduits for supplying pressurized brake fluid in the second front wheel cylinder by suction and discharging the brake fluid stored in the reservoir;
a fourth pump located in the fourth one of the four conduits for supplying pressurized brake fluid in the second rear wheel cylinder by suction and discharging the brake fluid stored in the reservoir;
a first conduit system arranged in the main conduit and including the first pump and the second pump for supplying the pressurized brake fluid to the first front wheel cylinder and the first rear wheel cylinder, respectively;
a second conduit system arranged in the main conduit and including the third pump and the fourth pump for supplying the pressurized brake fluid to the second front wheel cylinder and the second rear wheel cylinder, respectively;
a first motor provided at the first conduit system for driving the first and the second pumps;
a first rotation sensor provided at the first motor for detecting a rotation of the first motor;
a second motor provided at the second conduit system for driving the third and the fourth pumps;
a second rotation sensor provided at the second motor for detecting a rotation of the second motor;
first, second, third and fourth pressure modulating circuits arranged in parallel with the first, second, third and fourth pumps for returning the brake fluid in the first and the second conduit systems to the reservoir;
first, second, third and fourth linear valves provided at the corresponding first, second, third and fourth pressure modulating circuits, respectively;
controlling means for driving the first, second, third and fourth linear valves and the first and the second motors based on a detection signal from the operation amount sensor, the controlling means including;
a target wheel cylinder pressure calculating portion for calculating a target wheel cylinder pressure corresponding to the operation amount detected by the operation amount sensor and calculating a necessary amount of brake fluid necessary for generating the wheel cylinder pressure corresponding to the target wheel cylinder pressure when the brake operating member is detected to be operated;
an accumulated motor rotation calculating means for calculating an accumulated number of rotations of each of the first and the second motors on the basis of a detection signal from the first and the second rotation sensors after the brake operating member is operated; and
a motor actuation determining portion determining whether the necessary amount of brake fluid is larger than a current amount which is calculated by multiplying the brake fluid discharged from the first, second, third and fourth pumps per one rotation of the first and the second motors by the accumulated number of rotation, wherein
the brake fluid in the first and the second front wheel cylinders and the first and the second rear wheel cylinders are pressurized by driving the first, second, third and fourth linear valves and the first and the second motors when the necessary amount of brake fluid is judged to be larger than the current amount of brake fluid and the brake fluid in the first and the second front wheel cylinders, and the pressurizing of the first and the second rear wheel cylinders are stopped by reducing the number of rotations or stopping the rotation of the first and the second motors when the necessary amount of brake fluid is judged not to be larger than the current amount of brake fluid.

2. A brake control apparatus for a vehicle according to claim 1, wherein the number of rotations of the first and the second motors is set so that the brake fluid discharged from the first, second, third and fourth linear valves becomes a brake fluid level capable of pressure modulation when the necessary amount of brake fluid is judged not to be larger than the current amount of brake fluid.

3. A brake control apparatus for a vehicle, comprising:
a brake operating member operated by an operator of the vehicle;
an operation amount sensor for detecting an operation amount of the brake operating member;
first and second front wheel cylinders mounted at first and second front wheels of the vehicle respectively;
first and second rear wheel cylinders mounted at first and second rear wheels of the vehicle respectively;
a reservoir for storing brake fluid;
a main conduit connecting the first and second front wheel cylinders and the first and second rear wheel cylinders with the reservoir, the main conduit branching into four conduits respectively connected with the first and second front wheel cylinders and the first and second rear wheel cylinders;
a first pump, located in the first one of the four conduits, for pressurizing a first one of the first front wheel cylinder, the second front wheel cylinder, the first rear wheel cylinder, and the second rear wheel cylinder by suction and discharging the brake fluid stored in the reservoir;
a second pump, located in the second one of the four conduits, for pressurizing a second one of the first front wheel cylinder, the second front wheel cylinder, the first rear wheel cylinder, and the second rear wheel cylinder by suction and discharging the brake fluid stored in the reservoir;
a third pump, located in the third one of the four conduits, for pressurizing a third one of the first front wheel cylinder, the second front wheel cylinder, the first rear wheel cylinder, and the second rear wheel cylinder by suction and discharging the brake fluid stored in the reservoir;
a fourth pump, located in the fourth one of the four conduits, for pressurizing a fourth one of the first front wheel cylinder, the second front wheel cylinder, the first rear wheel cylinder, and the second rear wheel cylinder by suction and discharging the brake fluid stored in the reservoir;
a first conduit system arranged in the main conduit and including the first pump and the second pump for supplying the pressurized brake fluid to the first one of the first front wheel cylinder, the second front wheel cylinder, the first rear wheel cylinder, and the second rear wheel cylinder and the second one of the first front wheel cylinder, the second front wheel cylinder, the first rear wheel cylinder, and the second rear wheel cylinder;
a second conduit system arranged in the main conduit and including the third pump and the fourth pump for supplying the pressurized brake fluid to the third one of the first front wheel cylinder, the second front wheel cylinder, the first rear wheel cylinder, and the second rear wheel cylinder and the fourth one of the first front wheel cylinder, the second front wheel cylinder, the first rear wheel cylinder, and the second rear wheel cylinder;
a first motor provided at the first conduit system for driving the first and the second pumps;
a first rotation sensor provided at the first motor for detecting a rotation of the first motor;
a second motor provided at the second conduit system for driving the third and the fourth pumps;
a second rotation sensor provided at the second motor for detecting a rotation of the second motor;
first, second, third and fourth pressure modulating circuits arranged in parallel with the first, second, third and fourth pumps for returning the brake fluid in the first and the second conduit systems to the reservoir;
first, second, third and fourth linear valves provided at the corresponding first, second, third and fourth pressure modulating circuits, respectively;
controlling means for driving the first, second, third and fourth linear valves and the first and the second motors based on a detection signal from the operation amount sensor, the controlling means including;
a target wheel cylinder pressure calculating portion for calculating a target wheel cylinder pressure corresponding to the operation amount detected by the operation amount sensor and calculating a necessary amount of brake fluid necessary for generating the wheel cylinder pressure corresponding to the target wheel cylinder pressure when the brake operating member is detected to be operated;
an accumulated motor rotation calculating means for calculating an accumulated number of rotations of each of the first and the second motors on the basis of a detection signal from the first and the second rotation sensors after the brake operating member is operated; and
a motor actuation determining portion determining whether the necessary amount of brake fluid is larger than a current amount which is calculated by multiplying the brake fluid discharged from the first, second, third and fourth pumps per one rotation of the first and the second motors by the accumulated number of rotation, wherein
the brake fluid in the first and the second front wheel cylinders and the first and the second rear wheel cylinders are pressurized by driving the first, second, third and fourth linear valves and the first and the second motors when the necessary amount of brake fluid is judged to be larger than the current amount of brake fluid and the brake fluid in the first and the second front wheel cylinders, and the pressurizing of the first and the second rear wheel cylinders are stopped by reducing the number of rotations or stopping the rotation of the first and the second motors when the necessary amount of brake fluid is judged not to be larger than the current amount of brake fluid.
